(19) United States
(12) Patent Application Publication
(10) Pub. No.: US 2013/0034758 A1
(43) Pub. Date: Feb. 7, 2013

(54) ACCUMULATOR ARRANGEMENT

(71) Applicants: Henrik RAEDSCH, Roedermark (DE); Martin NUETZ, Eppstein/Taunus (DE)

(72) Inventors: Henrik RAEDSCH, Roedermark (DE); Martin NUETZ, Eppstein/Taunus (DE); Harald DREHER, Seelze (DE)

(73) Assignee: GM GLOBAL TECHNOLOGY OPERATIONS LLC, Detroit, MI (US)

(21) Appl. No.: 13/475,165

(22) Filed: May 18, 2012

(30) Foreign Application Priority Data
May 20, 2011 (DE) 10 2011 102 102.0

(51) Int. Cl. H01M 10/48; H01M 2/20; H01M 2/10

(52) U.S. Cl. 429/90; 429/149; 429/99; 429/160

(57) ABSTRACT

An accumulator arrangement for a motor vehicle is provided. The accumulator arrangement includes an array of a plurality of galvanically connected accumulator cells. Each cell is individually removable from the array and replaceable.

### CROSS-REFERENCE TO RELATED APPLICATION

This application claims priority to German Patent Application No. 10 2011 102 102.0, filed May 20, 2011, which is incorporated herein by reference in its entirety.

### TECHNICAL FIELD

The technical field generally relates to an accumulator arrangement, in particular a starter accumulator arrangement, for a motor vehicle.

### BACKGROUND

Accumulators on lead-acid base have been employed in motor vehicles for decades and have achieved a high degree of reliability. Large series production and the fact that the technology is mastered by many competing manufacturers makes these accumulators available economically, so that they are still installed in new vehicles even at present, although more modern accumulator types have a lower self-depletion and a higher energy density and, because of the possibility of the weight savings and accompanied reduction of the fuel consumption, should constitute an attractive alternative in the automotive sector. Another reason for the persistent use of lead-acid accumulators in the automotive sector is that many private consumers with other accumulator types, for example in mobile computers, mobile phones etc., experience that the lifespan of these accumulators is shorter than that of a lead-acid accumulator and the costs for a replacement are disproportionately high.

Regardless of whether this impression is objectively correct, there is therefore a need for a technology, which in a manner that is understandable to the private user, reduces the operating costs of an accumulator system.

### SUMMARY

An accumulator arrangement for a motor vehicle with an array of a plurality of galvanically connected accumulator cells, wherein each accumulator cell can be individually removed from the array and replaced, is provided herein. An individual accumulator cell, regardless on which technology it is based, is not able alone to supply the required voltage conventionally required for operating a motor vehicle on-board system. For generating this voltage a plurality of cells are galvanically connected in series. An accumulator arrangement of accumulator cells connected in series, however, is always only as strong as its weakest link, i.e. when an accumulator cell of a series connection is faulty and only has a fraction of its original capacity or an elevated internal resistance, it limits the charge rate that can be stored again in the accumulator arrangement and removed from it again, and the electric power that can be supplied by the accumulator arrangement. An accumulator arrangement in which each accumulator cell can be individually removed offers the possibility of individually checking the accumulator cells in such a case and, instead of replacing a complete arrangement with high costs, only replacing the accumulator cell that is weak or faulty, and to re-use the others.

Here, the term “accumulator cell” should not be understood to be restricted to an individual galvanic cell. Although an accumulator cell can be a galvanic cell, it can, however, comprise a plurality of galvanic cells, in particular a series connection of two galvanic cells, as will still be explained in more detail later on.

It is to be understood that such an accumulator arrangement is particularly useful in the case of cells which are being manufactured according to a technology that is not optimally mastered and therefore have a relatively high probability for error or premature failure, but that these can, in principle, be applied with accumulators of any type.

In an embodiment, in order to make possible a comfortable and safe removal of cells, the group comprises a frame, in which mountings for the cells are formed.

In an embodiment, an accumulator arrangement has cells that are subdivided in a plurality of groups, wherein each group comprises a plurality of shunt-connected cells and the groups among themselves are connected in series. If the storage capacity of the individual cells varies because of the manufacturing tolerances, the same will then apply also to the groups, the storage capacity of which in each case corresponds to the sum of the capacities of their cells.

The possibility of exchanging cells also gives rise to the possibility of assembling the individual groups from cells of different storage capacity so that the capacities of the groups on a percentage basis differ significantly less than those of the individual cells. When in an ideal case the capacities of all groups are identical, it is possible to fully charge or fully discharge all cells simultaneously and fully utilize their storage capacity.

A standardization of the storage capacity of the individual groups is more accurate the greater the number of the cells in the group is. It is therefore In one embodiment, therefore, each group comprises at least three cells.

In an embodiment, in order to make possible checking of the cells without utilising external resources, a test circuit for checking the capacity of each individual cell is part of the accumulator arrangement.

A display device for displaying at least one instruction identifying an individual cell and/or at least one instruction identifying a pair of cells is provided, in accordance with an embodiment. The instruction identifying an individual cell can describe a defective cell, which is to be replaced with a new one; an instruction identifying a pair of cells can be directed at two cells of different groups which are to be interchanged, in order to reduce the difference between the capacities of the groups.

Because of its high energy density and low self-depletion, cells comprising lithium ions as charge carriers, in particular, cells of the LiFePO4 type, are utilized in one embodiment.

In addition, other objects, desirable features and characteristics will become apparent from the subsequent detailed description, and the appended claims, taken in conjunction with the accompanying drawings and this summary.

### BRIEF DESCRIPTION OF THE DRAWINGS

The various embodiments will hereinafter be described in conjunction with the following drawing figures, wherein like numerals denote like elements, and wherein:

FIG. 1 a perspective view of an accumulator arrangement according to an embodiment;

FIG. 2 a circuit diagram of the accumulator arrangement from FIG. 1;

FIG. 3 a circuit diagram of the accumulator arrangement from FIG. 1 upon a checking of its cells;

FIG. 4 an exemplary display figure, which can be obtained as result of a first checking of the accumulator arrangement from FIG. 1;

FIG. 5 an exemplary display image, which can be obtained as result of a second checking of the accumulator arrangement from FIG. 1; and

FIG. 6 a circuit diagram in accordance with another embodiment.

### DETAILED DESCRIPTION

The following detailed description is merely exemplary in nature and is not intended to limit the exemplary embodiments or the application and uses thereof Furthermore, there is no intention to be bound by any theory presented in the preceding background or the following detailed description.

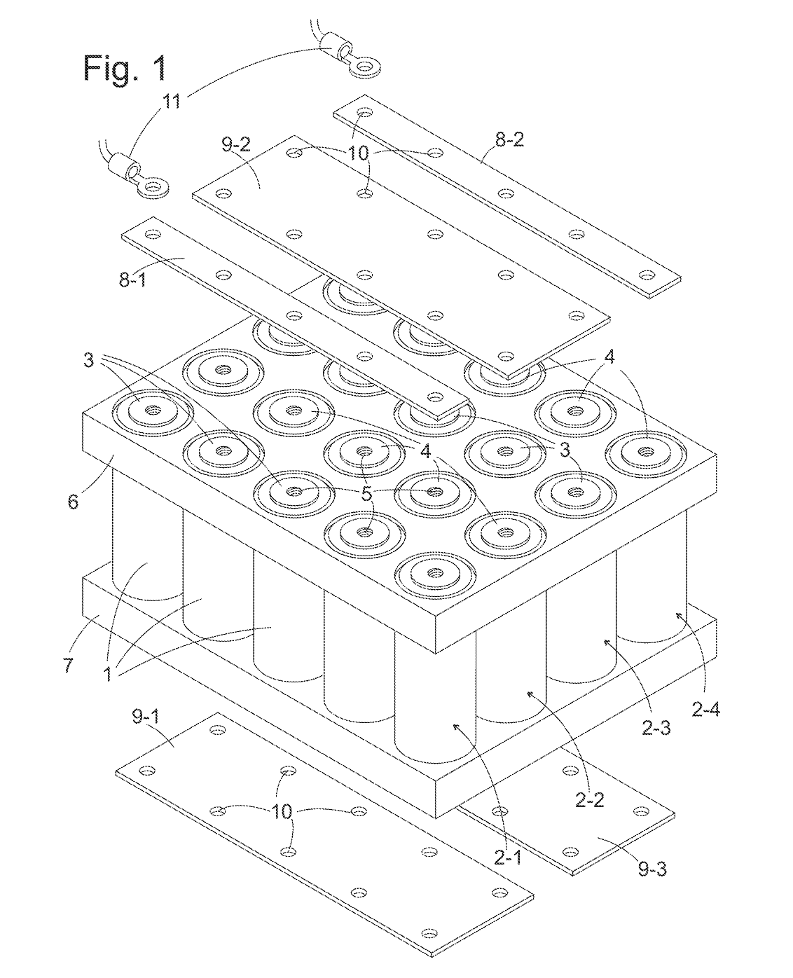

FIG. 1 shows, in an exemplary embodiment, an accumulator arrangement with a total of 20 galvanic cells 1, which form four groups 2-1, 2-2, 2-3, 2-4 of five cells each arranged next to one another. The cells 1 are each cylindrical with anodes 3 and cathodes 4 on opposing face ends each. Anodes and cathodes are each provided with axially orientated threaded bores 5.

The positions of the cells 1 relative to one another are determined transversely to their axes by two frame elements 6, 7 with bores, each of which receive the two ends of the cells 1. The spacing of the frame elements 6, 7 from one another can be determined by spacers (not shown) between the frame elements or in that the frame elements in each case support themselves locally on the end faces of the cells.

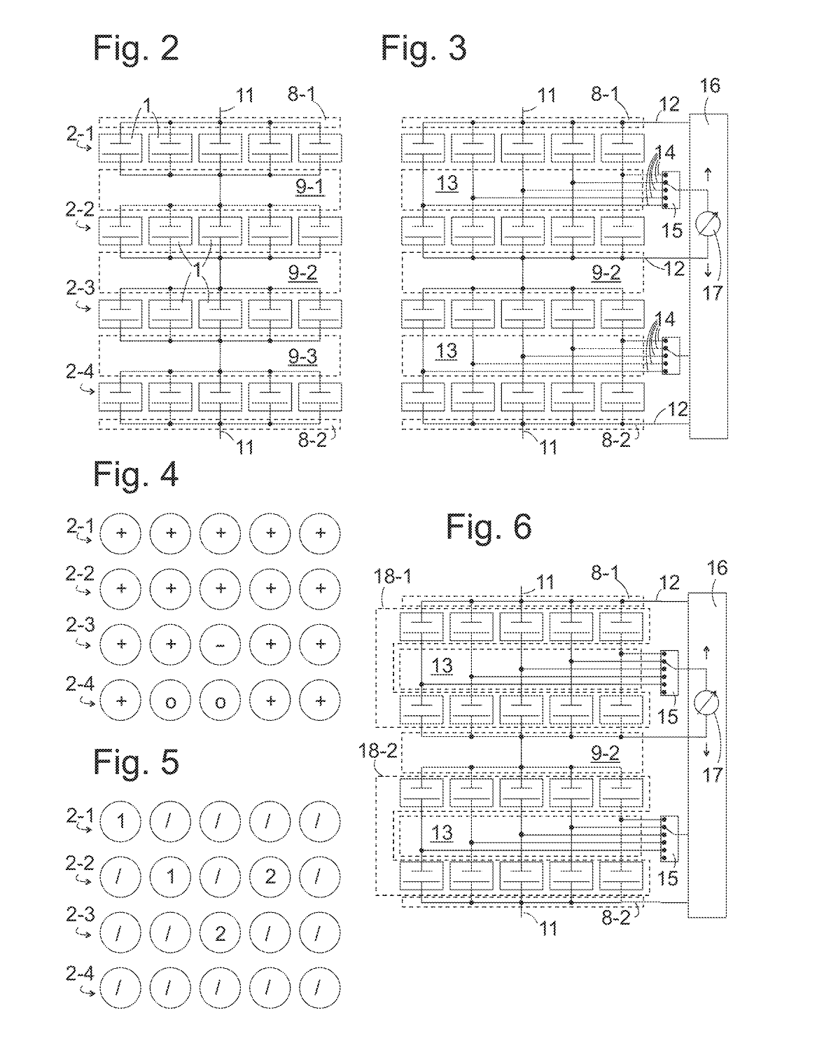

Circuit boards 8-1, 8-2, 9-1, 9-2, 9-3 each with one or two rows of bores 10 are interconnected in a conductive manner by the alignment with the threaded bores 5 of the cells 1 and can be galvanically connected to these by screws (not shown) for fixing the cells 1 in axial direction and their inter-contacting. The orientation of the cells 1 within each group 2-1, . . . 2-4 is identical, and it changes from one group to the next, so that when the circuit boards 8-1, 8-2, 9-1, 9-2, 9-3 shown in FIG. 1 are all assembled, they connect cells 1 placed in a same group in parallel and the groups 2-1 to 2-4 among themselves in series, as shown in the circuit diagram of FIG. 2.

In one embodiment, because of their high energy density, lithium ion accumulators are employed as cells 1, the terminal voltage of which amounts to between 3.3 and 3.8 v each depending on the electrode material. In another embodiment, for use in a motor vehicle, LiFePO4 cells are employed whose terminal voltage is approximately 3.3 v, for, by connecting four such cells in series, an output voltage can be achieved which quite accurately corresponds to the on-board system voltage of 12 v that is currently widespread in most passenger cars.

In accordance with an exemplary embodiment, in order to test the individual cells 1 of the accumulator arrangement of FIG. 1 or 2, in analogy to the supply connection terminals 11 on the circuit boards 8-1, 8-2 shown in FIG. 1, test connection terminals 12 (see FIG. 3) are attached to all three upper circuit boards 8-1, 8-2, 9-1 and the lower circuit boards 9-1, 9-3 are replaced with circuit boards 13, which, as is likewise shown in FIG. 3, are internally structured in order to connect two cells 1 belonging to different rows 2-1, 2-2 or 2-3, 2-4 to one of five test connections 14 each, corresponding to the number or cells in each group. One of the test connections 14 of the circuit board 13 is connected to a test arrangement 16 via a switch 15.

The test arrangement 16 shown in FIG. 3 comprises a test circuit 17, which, as indicated by vertical arrows, can be connected to two random adjacent connections of the test arrangement 16, i.e. with one of the switches 15 and one of the test connections 12 each in order to impose, for example, a charge current to a single cell 1 determined through the selection of the connections and the position of the switch 15 and to measure the resultant charge voltage, to measure a discharge current, or carry out other measurements suitable for evaluating the quality and capacity of the cell 1. In the test arrangement 16, a plurality of test circuits 17 up to one for each group 2-1, 2-2, 2-3, 2-4 could also be provided in order to carry out measurements on cells 1 of different groups simultaneously.

FIG. 4 shows an example for a possible result of such a measurement, which is displayed on a display monitor connected to the test arrangement 16 or can be output via a printer. It is also conceivable to attach to the frame element 6 or 7 display elements each in local relationship to a cell 1, which can be activated from the test arrangement 16 so that the state of each display element displays the test result of the adjacent cell 1. While the two uppermost groups 2-1, 2-2 of FIG. 4—indicated here by a plus sign—only contain intact cells 1, the middle cell of the third group 2-3 is defective, here identifiable by a minus sign, and should be replaced. The lowermost group 2-4 contains two cells of doubtful quality, indicated by a zero, which could require replacement in the near future.

A second type of possible test result is shown in FIG. 5. Here, the test arrangement 16 has calculated total capacities for each group 2-1 to 2-4 by means of the measurements of the capacities of the individual cells 1. Since the groups 2-1 to 2-4 are connected in series, their capacities should be equal in order to charge and discharge all groups as uniformly as possible, thus avoiding overloading of weak cells through extreme charging or discharging. When for example such a measurement has yielded a particularly high total capacity of the group 2-2, the user gleans from the test result shown in FIG. 5 the instruction of replacing the cells 1 designated 1 or 2 of group 2-2 with cells of lower capacity of the group 2-1 and 2-3, respectively, likewise designated equally with 1 and 2, respectively, suitably selected by the test arrangement 16, in order to obtain groups with preferably identical total capacities.

FIG. 6 shows a circuit diagram of an accumulator arrangement which allows a change-over between charging/discharging by way of the supply connections 11 and testing of the individual cells 1 with reduced effort, in another embodiment. Here, the galvanic cells 1 are combined into two groups 18-1, 18-2, wherein each group comprises five shunt-connected arrangements of two series-connected galvanic cells 1 each. The accumulator arrangement can likewise have the structure shown in FIG. 1, so that each galvanic cell 1 is individually exchangeable. With this configuration, the circuit boards 13 remain installed even during charging and discharging of the cells 1 via the supply connections 11, and the switches 15 have a switching position, in which they do not connect the test circuit 17 with any of the test connections 14. With this configuration, the test arrangement 16 can be permanently installed since its presence, with the switches 15 open, has no effect on the charging and discharging operation of the cells 1 whatsoever.

Testing of the cells 1 through the test arrangement 16 can also initially serve for the separating-out of defective cells 1, as described with reference to FIG. 4. If no defective cells 1 are present, a further optimisation step of the test arrangement 16 consists in finding pairs of cells 1 each with preferably similar values of charging capacity and/or internal resistance, each of which should be connected in series by pairs. The 10 pairs obtained in this manner are subsequently allocated by the test arrangement 16 to the groups 18-1, 18-2 so that the total charge capacities of both groups differ as little as possible from each other. The exchanges of cells 1, that are required in order to establish the determined arrangement, are displayed in turn in the form of a diagram analogous to FIG. 5.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. An accumulator arrangement for a motor vehicle, the accumulator arrangement comprising:
an array of a plurality of galvanically connected accumulator cells, wherein each cell is individually removable from the array and replaceable.

2. The accumulator arrangement according to claim 1, wherein the accumulator arrangement is a starter accumulator arrangement.

3. The accumulator arrangement according to claim 1, wherein the array further comprises a frame that receives an end of each of the plurality of galvanically connected accumulator cells.

4. The accumulator arrangement according to claim 1, wherein the plurality of galvanically connected accumulator cells is subdivided into a plurality of groups, wherein each of the plurality of groups comprises a plurality of shunt-connected cells and the plurality of groups are connected together in series.

5. The accumulator arrangement according to claim 4, wherein each of the plurality of groups comprises at least three cells and wherein the at least three cells within each of the plurality of groups is connected in parallel relative to each other.

6. The accumulator arrangement according to claim 1, further comprising a test circuit for testing a capacity of each of the plurality of galvanically connected accumulator cells.

7. The accumulator arrangement according to claim 1, further comprising a display device for displaying an instruction identifying an individual cell of the plurality of galvanically connected accumulator cells and/or an instruction identifying a pair of cells of the plurality of galvanically connected accumulator cells.

8. The accumulator arrangement according to claim 7, wherein the instruction identifying the individual cell of the plurality of galvanically connected accumulator cells describes a defective cell.

9. The accumulator arrangement according to claim 7, wherein the plurality of galvanically connected accumulator cells is subdivided into a plurality of groups, wherein each of the plurality of groups comprises a plurality of shunt-connected cells and the plurality of groups are connected together in series, and wherein the instruction identifying the pair of cells describes two cells of different groups, an exchange of which reduces a difference between capacities of the plurality of groups.

10. The accumulator arrangement according to claim 1, wherein each of the plurality of galvanically connected accumulator cells comprises LI-ions as charge carriers.

11. The accumulator arrangement according to claim 1, wherein each of the plurality of galvanically connected accumulator cells are of a LiFePO4 type.
